(19) United States
(12) Patent Application Publication
(10) Pub. No.: US 2009/0228906 A1
(43) Pub. Date: Sep. 10, 2009

(54) NATIVE SUPPORT FOR MANIPULATION OF MULTIMEDIA CONTENT BY AN APPLICATION

(76) Inventors: Sean Kelly, Cupertino, CA (US); Lucas C. Newman, San Francisco, CA (US); Charles John Pisula, Bethesda, MD (US)

Correspondence Address: APPLE INC./BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/398,113

(22) Filed: Mar. 4, 2009

Related U.S. Application Data
(60) Provisional application No. 61/033,770, filed on Mar. 4, 2008.

(51) Int. Cl. G06F 9/46; G09G 5/00

(52) U.S. Cl. 719/328; 345/659

(57) ABSTRACT

The present disclosure generally relates to providing third party applications a standardized framework for integrating multimedia content. In particular, in some embodiments application programming interfaces (APIs) are provided that allow the third party application to easily integrate multimedia content.

The present application claims priority to U.S. Provisional Application No. 61/033,770, filed Mar. 4, 2008, and entitled APPLICATION PROGRAMMING INTERFACES FOR DISPLAYING CONTENT ON A MOBILE COMPUTING DEVICE, which is hereby incorporated by reference.

### BACKGROUND

1. Technical Field

This disclosure generally relates to mobile computing devices. More specifically this disclosure relates to computer-implemented methods and systems for enabling third party applications to display content on a mobile computing device.

2. Description of the Related Technology

Some mobile computing devices offer application programming interfaces (APIs) to third party applications. Such APIs may be important because they can allow third parties to develop applications for these devices.

However, a significant problem with offering APIs is protecting the stability of the device. An ill-structured application can dramatically hurt the performance and stability of a device, especially a mobile computing device. These issues are especially problematic when the third party application is attempting to display and animate sophisticated content on a mobile computing device. For example, many applications often incorporate a video or other multimedia content as part of their content.

Accordingly, it would be desirable to provide APIs in a mobile computing device that allows for efficient and stable display of multimedia content on a mobile computing device.

### BRIEF DESCRIPTION OF THE DRAWINGS

FIG. 1 illustrates a system configured to enable a third party application to place content on a display of a mobile computing device, in accordance with some embodiments of the inventions.

FIG. 2 illustrates use the software development kit of FIG. 1.

FIG. 3 is a block diagram of a mobile computing device shown in FIG. 1.

FIG. 4 illustrates a high level architecture for the mobile computing device of FIG. 1.

FIG. 5A illustrates an example embodiment of a mobile device.

FIG. 5B illustrates an example embodiment of a configurable top-level graphical user interface of a mobile device.

FIG. 6 is a block diagram of an example implementation of a mobile device.

### DETAILED DESCRIPTION

The present disclosure generally relates to providing third party applications a standardized framework for integrating multimedia content. In particular, in some embodiments application programming interfaces (APIs) can be provided that allow the third party application to easily integrate multimedia content.

Embodiments of the invention will now be described with reference to the accompanying Figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

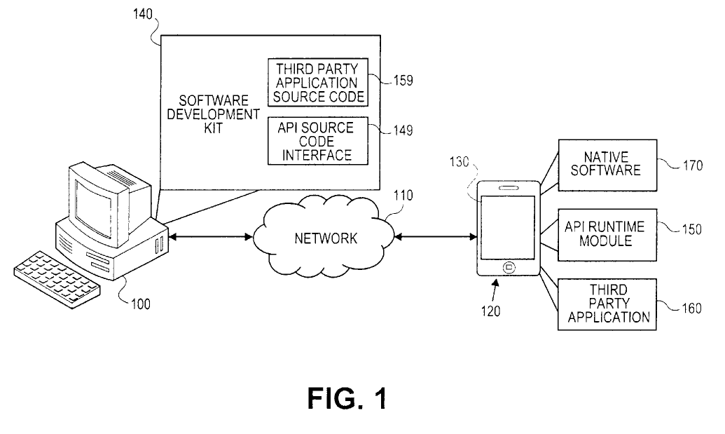

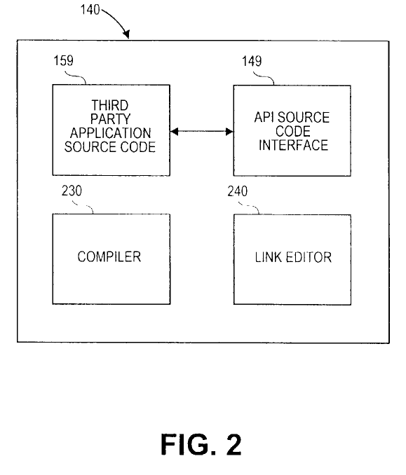

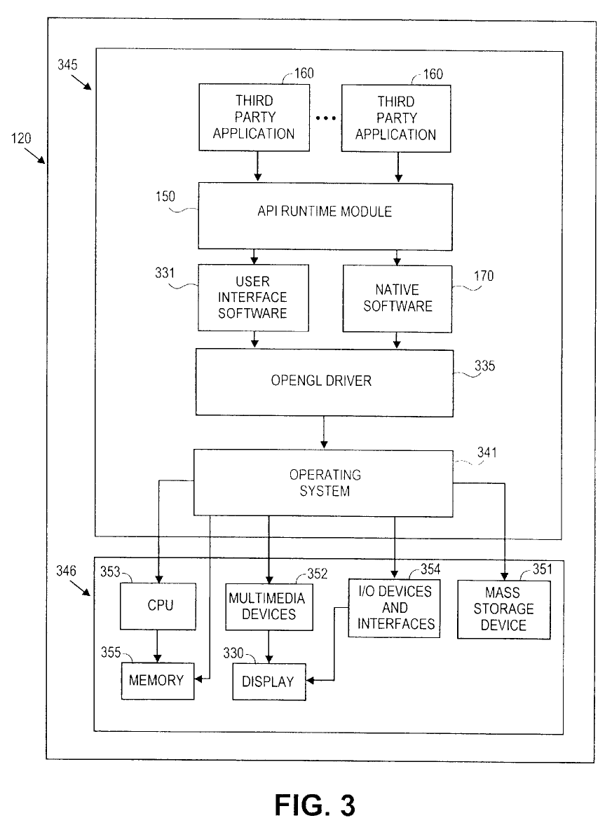

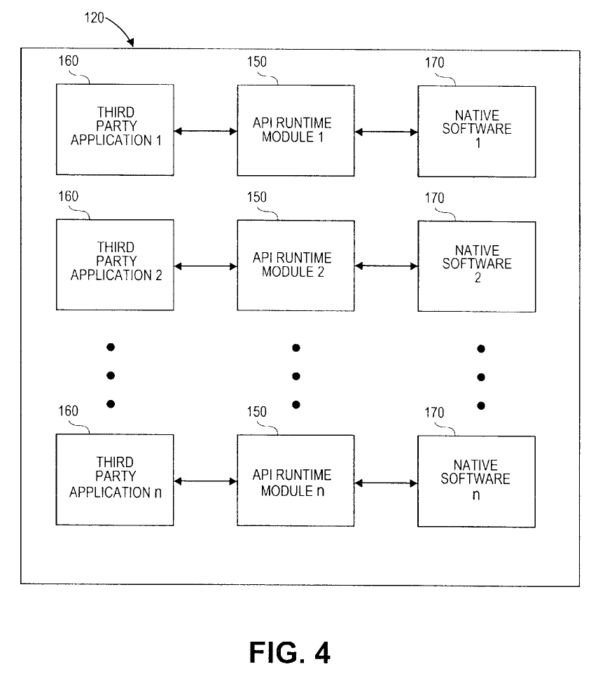

In order to help illustrate the embodiments, FIGS. 1-4 will now be presented. FIG. 1 illustrates an exemplary development system in which a developer may use a software development kit to configure their third party application to utilize various APIs for user interface views and control elements. FIG. 2 illustrates a block diagram of the software development kit. FIGS. 3-4 are then provided to show block diagrams of a mobile computing device and various third party applications running on the mobile computing device. Reference will now be made to FIG. 1 in order to describe an exemplary development system.

As shown in FIG. 1, computing system 100 may be in communication with network 110, and/or mobile computing device 120 may also in communication with network 110. Communication over network 110 can take place using sockets, ports, and/or other mechanisms recognized in the art. Mobile computing device 120 includes display 130 to place content, such as animation, for viewing by a user of the device.

Mobile computing device 120 can be a cell phone, smart phone, personal digital assistant, audio player, and/or the like. For example, in some embodiments, mobile computing device 120 can be an Apple iPhone™, iPod™, and the like.

Mobile computing device 120 can further include application programming interface runtime module 150. Runtime module 150 can be configured to enable third party application 160 to communicate with native software 170 to place content on display 130 of the computing device 120. Third party application 160 can use application programming interface runtime module 150 to make requests for services of native software 170. Third party application 160 can be a variety of different applications, such as games, tools, etc.

Native software 170 may generally represent software installed on mobile computing device 120 that supports the execution of third party application 160. For example, native software 170 may refer to the operating system, user interface software, graphics drivers, and the like that is installed and running on mobile computing device 120.

In order to configure third party application 160, computing system 100 can include software development kit 140. Software development kit 140 can allow a developer to configure third party application source code 159 to access application programming interface (API) source code interface 149. For example, in some embodiments, application programming interface (API) source code interface 149 can include a header file written in the Objective-C programming language.

Third party application source code 159 can be compiled into third party application 160, in the form of object code. This object code can then be linked to application programming interface (API) runtime module 150. API runtime module 150 can include one or more executable object code interfaces to native software 170 that implement and/or correspond to API source code interface 149 provided to third party application source code 159. Native software 170 can include object code that is readable by mobile computing device 120.

Third party application 160, application programming interface runtime module 150, and native software 170 can then be stored and executed on mobile computing device 120. The term application programming interface (API) is used herein to refer generally to the interface(s) for making service requests provided by API source code interface 149 (source code level) to third party application source code 159 or API runtime module 150 (object code level) to third party application 160.

Software development kit 140 can be configured to enable third party application 160 to be written for mobile computing device 120. Network 110 can then be used, in some embodiments, to transfer and load third party application 160 onto mobile computing device 120. In some embodiments, third party application 160 can be configured to use application programming interface runtime module 150 to place its content within user interface views and accompanying control elements on display 130 of mobile computing device 120 at runtime. In some embodiments, application programming interface runtime module 150 can provide various interfaces to the native software 170. Native software 170 can then be called at runtime to place the viewing content on display 130 of mobile computing device 120.

The functionality provided for in the components, applications, application programming interfaces, and/or modules described herein can be combined and/or further separated. In general, the words module, interface, and/or application as used herein, refers to logic embodied in hardware or firmware, or to a collection of software instructions, possibly having entry and exit points, written in a programming language, such as, for example, Java, Objective-C, C or C++. A software module, interface, and/or application may be compiled and linked into an executable program, installed in a dynamic link library, or may be written in an interpreted programming language such as, for example, BASIC, Perl, or Python. It will be appreciated that software modules, interfaces, and/or applications may be callable from other modules and/or applications, or from themselves, and/or may be invoked in response to detected events or interrupts. Software instructions may be embedded in firmware, such as an EPROM. It will be further appreciated that hardware modules, interfaces and/or applications may include connected logic units, such as gates and flip-flops, and/or may include programmable units, such as programmable gate arrays or processors. The modules, interfaces and/or applications described herein are preferably implemented as software modules, interfaces, and/or applications, but may be represented in hardware or firmware. Generally, the modules, interfaces, and/or applications described herein refer to logical modules, interfaces, and/or applications that may be combined with other modules, interfaces, and/or applications or divided into sub-modules, sub-interfaces, and/or sub-applications despite their physical organization or storage.

FIG. 2 illustrates a block diagram of the software development kit of FIG. 1. Software development kit 140 may be configured to enable third party application source code 159 to access API source code interface 149 to animate content on display 130 of mobile computing device 120. API source code interface 149 can include a header file.

In various embodiments, software development kit 140 may be used to help interface with native software 170. Native software 170 represents any software that was natively installed on mobile computing device 120. For example, in the present disclosure, native software 170 may refer to user interface software 331, graphics driver 335, and operating system 341.

For the developer, software development kit 140 can also include compiler 230. Compiler 230 can be configured to translate third party application source code 159 into a target form, referred to herein as third party application 160. The form of third party application 160 can include object code and/or binary code. Advantageously, compiler 230 can provide an option of generating object code that can be run on computing system 100 or mobile computing device 120. Compiler 230 can be a compiler for object-oriented languages such as Java, Objective-C, Ada, or C++, or a compiler for procedural languages, such as C.

Software development kit 140 can also include link editor 240. In some embodiments, third party application source code 159 can be compiled into third party application 160. Link editor 240 can then be used to link third party application 160 to API runtime module 150. A service request can then be sent from third party application 160 to API runtime module 150 on mobile computing device 120 at runtime. When loaded on mobile computing device 120, third party application 160 can then access native software 170 through API runtime module 150. In an embodiment, third party application 160 can then access native software 170 to place content on display 130 of mobile computing device 120.

In some embodiments, the service request can include sending as input to an application programming interface (API) a string of a first size for scaling to a second size such that the second size fits display 130 of mobile computing device 120. In some embodiments, the service request can include requesting the API to detect movement of mobile computing device 120, and in response to a detection of movement requesting the API to adjust an orientation of the content on display 130. In some embodiments, the service request can include sending as input to the API a first image for stretching and displaying on mobile computing device 120. In some embodiments, the service request can include rendering and displaying on mobile computing device 120 an input text string formatted in a Hypertext Markup Language (HTML).

FIG. 3 illustrates a block diagram of a mobile computing device 120. As shown, mobile computing device 120 may include a software level 345 and hardware level 346. At software level 345, third party application 160 may utilize application programming interface (API) runtime module 150 to request services from user interface software 331 or graphics driver 335 to display content on display 130.

In block 331, user interface software 331 may help render certain aspects, such as animations, of the document content and document presentation. User interface software 331 can be a data visualization software that is used by Apple's Mac OS X 10.5 to produce animated user interfaces. In some embodiments, for example, user interface software 331 can include Core Animation. Through API runtime module 150, user interface software 331 provides a way for third party developers to produce animated user interfaces via an implicit animation model. User interface software 331 is provided as an example of native software 170 and one skilled in the art will recognize that a third party application 150 may interface with other native applications, such as graphics driver 335 and one or more components of operating system 341.

In block 335, an graphics driver 335 may be used by user interface software 331 to help render any animations in third party application 160. In some embodiments, graphics driver 335 may be an OpenGL-based driver. OpenGL is a standard specification defining a cross-language cross-platform API for writing applications that produce 2D and 3D computer graphics. OpenGL can be used to draw complex three-dimensional scenes from simple primitive shapes or models. It may be appreciated that other hardware or software acceleration may be used to help render any animations in third party application 160.

Operating system (OS) layer 341 may control mobile computing device 120. Operating system layer 341 may include Mac OS X, Linux, Windows, or any number of proprietary operating systems. Conventional operating systems control and schedule computer processes for execution, perform memory management, provide file system, networking, and I/O services, and provide a user interface, such as a graphical user interface (GUI), among other things.

In hardware level 346, mobile computing device 120 can include memory 355, such as random access memory (RAM) for temporary storage of information and a read only memory (ROM) for permanent storage of information, and mass storage device 351, such as a hard drive, diskette, or optical media storage device. Mass storage device 351 may include one or more hard disk drives, optical drives, networked drives, or some combination of various digital storage systems. Mobile computing device 120 also includes central processing unit (CPU) 353 for computation. Typically, the modules of the computing device 120 are in data communication via one or more standards-based bus systems. In different embodiments, the standards based bus system could be Peripheral Component Interconnect (PCI), Microchannel, SCSI, Industrial Standard Architecture (ISA) and Extended ISA (EISA) architectures, for example.

The exemplary mobile computing device 120 may include one or more of commonly available input/output (I/O) devices and interfaces 354, such as a touchpad, or keypad. In one embodiment, I/O devices and interfaces 354 include display 130 that allows the visual presentation of data to a user. More particularly, display devices provide for the presentation of GUIs, application software data, and multimedia presentations, for example. In one embodiment, a GUI includes one or more display panes in which images may be displayed. Mobile computing device 120 may also include one or more multimedia devices 352, such as speakers, video cards, graphics accelerators, and microphones. Multimedia devices 352 can include a graphics processing unit. Exemplary mobile computing devices 120 may include devices, such as Apple's iPhone™ and iPod™ touch devices.

FIG. 4 illustrates a high level architecture for the mobile computing device of FIG. 1. In the illustrated embodiment, mobile computing device 120 is configured to handle service requests to display content on mobile computing device 120 from third party applications 160 to native software 170. The content to place on display 130 of mobile computing device 120 can include animated content. As depicted in FIG. 4, a multitude of third party applications 160 can communicate with a multitude of API runtime modules 150. In the illustrated embodiments, the multitude of API runtime modules 150 can then each communicate with native software 170. In alternate embodiments, the multitude of API runtime modules 150 may each connect to a multitude of native software 170.

In some embodiments, when third party application 160 is executed, it can make a service request that includes calling API runtime module 150, which in turn can call the native software 170. API runtime module 150 can further be configured to return data to third party application 160 in response to a service request. API runtime module 150 can be configured to provide an interface to place content on display 130 of mobile computing device 120 to third party application 160. Advantageously, API runtime module 150 can access native software 170 without exposing the underlying implementation details to third party application 160.

As depicted by FIG. 4, the architecture is applicable to any environment that is designed to include third party applications 160, including mobile computing devices 120. The system allows for an immediate improvement in the security of native software 170 by hiding their implementation details from third party applications 160. The system also allows native software 170 to be modified without affecting third party application 160.

The interfaces illustrated can, in some embodiments, be divided or combined with other interfaces and/or be included in one or more separate APIs. The APIs offered will now be further described.

For example, the APIs can provide a media player interface (not shown) to third party application 160. In some embodiments, the media player interface can allow third party application 160 to manipulate media, including video and/or audio. In some embodiments, the media can include movies.

The media player interface can enable third party application 160 to play media, hide and/or display controls such as Heads-Up-Display (HUD) controls in Mac OS X, create a full screen player for a movie specified by a URL, and/or scale the media or player. In some embodiments, the media player interface can enable third party application 160 to control and/or specify transitions for media, set transitions between media, integrate media, control startup or shutdown of media, and/or specify a fade in and/or a fade out sequence for a media clip. For example, in some embodiments, the media player interface can allow a third party application 160 to insert a black screen transition in a media clip.

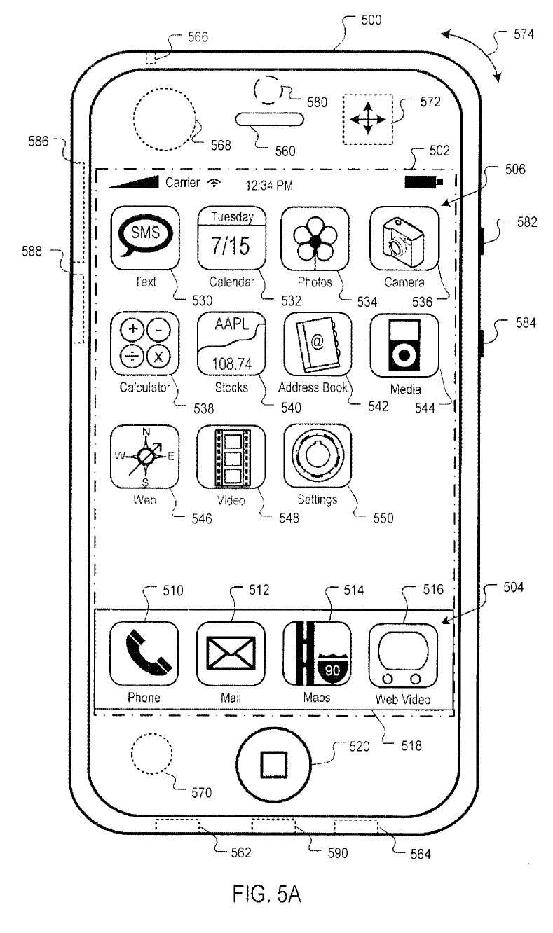

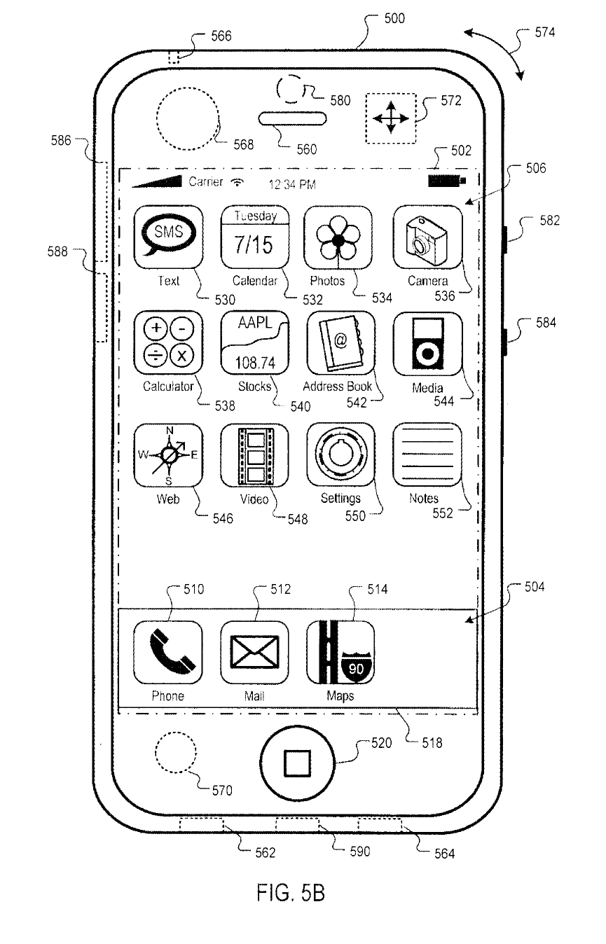

FIG. 5A illustrates an example mobile device 500. The mobile device 500 can be, for example, a handheld computer, a personal digital assistant, a cellular telephone, a network appliance, a camera, a smart phone, an enhanced general packet radio service (EGPRS) mobile phone, a network base station, a media player, a navigation device, an email device, a game console, or a combination of any two or more of these data processing devices or other data processing devices.

In some implementations, the mobile device 500 includes a touch-sensitive display 502. The touch-sensitive display 502 can be implemented with liquid crystal display (LCD) technology, light emitting polymer display (LPD) technology, or some other display technology. The touch-sensitive display 502 can be sensitive to haptic and/or tactile contact with a user.

In some implementations, the touch-sensitive display 502 can include a multi-touch-sensitive display 502. A multi-touch-sensitive display 502 can, for example, process multiple simultaneous touch points, including processing data related to the pressure, degree, and/or position of each touch point. Such processing facilitates gestures and interactions with multiple fingers, chording, and other interactions. Other touch-sensitive display technologies can also be used, e.g., a display in which contact is made using a stylus or other pointing device. Some examples of multi-touch-sensitive display technology are described in U.S. Pat. Nos. 6,323,846, 6,570,557, 6,677,932, and 6,888,536, each of which is incorporated by reference herein in its entirety.

In some implementations, the mobile device 500 can display one or more graphical user interfaces on the touch-sensitive display 502 for providing the user access to various system objects and for conveying information to the user. In some implementations, the graphical user interface can include one or more display objects 504, 506. In the example shown, the display objects 504, 506, are graphic representations of system objects. Some examples of system objects include device functions, applications, windows, files, alerts, events, or other identifiable system objects.

In some implementations, the mobile device 500 can implement multiple device functionalities, such as a telephony device, as indicated by a Phone object 510; an e-mail device, as indicated by the Mail object 512; a map devices, as indicated by the Maps object 514; a Wi-Fi base station device (not shown); and a network video transmission and display device, as indicated by the Web Video object 516. In some implementations, particular display objects 504, e.g., the Phone object 510, the Mail object 512, the Maps object 514, and the Web Video object 516, can be displayed in a menu bar 518. In some implementations, device functionalities can be accessed from a top-level graphical user interface, such as the graphical user interface illustrated in FIG. 5A. Touching one of the objects 510, 512, 514, or 516 can, for example, invoke a corresponding functionality.

In some implementations, the mobile device 500 can implement a network distribution functionality. For example, the functionality can enable the user to take the mobile device 500 and provide access to its associated network while traveling. In particular, the mobile device 500 can extend Internet access (e.g., Wi-Fi) to other wireless devices in the vicinity. For example, mobile device 500 can be configured as a base station for one or more devices. As such, mobile device 500 can grant or deny network access to other wireless devices.

In some implementations, upon invocation of a device functionality, the graphical user interface of the mobile device 500 changes, or is augmented or replaced with another user interface or user interface elements, to facilitate user access to particular functions associated with the corresponding device functionality. For example, in response to a user touching the Phone object 510, the graphical user interface of the touch-sensitive display 502 may present display objects related to various phone functions; likewise, touching of the Mail object 512 may cause the graphical user interface to present display objects related to various e-mail functions; touching the Maps object 514 may cause the graphical user interface to present display objects related to various maps functions; and touching the Web Video object 516 may cause the graphical user interface to present display objects related to various web video functions.

In some implementations, the top-level graphical user interface environment or state of FIG. 5A can be restored by pressing a button 520 located near the bottom of the mobile device 500. In some implementations, each corresponding device functionality may have corresponding “home” display objects displayed on the touch-sensitive display 502, and the graphical user interface environment of FIG. 5A can be restored by pressing the “home” display object.

In some implementations, the top-level graphical user interface can include additional display objects 506, such as a short messaging service (SMS) object 530, a Calendar object 532, a Photos object 534, a Camera object 536, a Calculator object 538, a Stocks object 540, a Address Book object 542, a Media object 544, a Web object 546, a Video object 548, a Settings object 550, and a Notes object (not shown). Touching the SMS display object 530 can, for example, invoke an SMS messaging environment and supporting functionality; likewise, each selection of a display object 532, 534, 536, 538, 540, 542, 544, 546, 548, and 550 can invoke a corresponding object environment and functionality.

Additional and/or different display objects can also be displayed in the graphical user interface of FIG. 5A. For example, if the device 500 is functioning as a base station for other devices, one or more “connection” objects may appear in the graphical user interface to indicate the connection. In some implementations, the display objects 506 can be configured by a user, e.g., a user may specify which display objects 506 are displayed, and/or may download additional applications or other software that provides other functionalities and corresponding display objects.

In some implementations, the mobile device 500 can include one or more input/output (I/O) devices and/or sensor devices. For example, a speaker 560 and a microphone 562 can be included to facilitate voice-enabled functionalities, such as phone and voice mail functions. In some implementations, an up/down button 584 for volume control of the speaker 560 and the microphone 562 can be included. The mobile device 500 can also include an on/off button 582 for a ring indicator of incoming phone calls. In some implementations, a loud speaker 564 can be included to facilitate hands-free voice functionalities, such as speaker phone functions. An audio jack 566 can also be included for use of headphones and/or a microphone.

In some implementations, a proximity sensor 568 can be included to facilitate the detection of the user positioning the mobile device 500 proximate to the user's ear and, in response, to disengage the touch-sensitive display 502 to prevent accidental function invocations. In some implementations, the touch-sensitive display 502 can be turned off to conserve additional power when the mobile device 500 is proximate to the user's ear.

Other sensors can also be used. For example, in some implementations, an ambient light sensor 570 can be utilized to facilitate adjusting the brightness of the touch-sensitive display 502. In some implementations, an accelerometer 572 can be utilized to detect movement of the mobile device 500, as indicated by the directional arrow 574. Accordingly, display objects and/or media can be presented according to a detected orientation, e.g., portrait or landscape. In some implementations, the mobile device 500 may include circuitry and sensors for supporting a location determining capability, such as that provided by the global positioning system (GPS) or other positioning systems (e.g., systems using Wi-Fi access points, television signals, cellular grids, Uniform Resource Locators (URLs)). In some implementations, a positioning system (e.g., a GPS receiver) can be integrated into the mobile device 500 or provided as a separate device that can be coupled to the mobile device 500 through an interface (e.g., port device 590) to provide access to location-based services.

In some implementations, a port device 590, e.g., a Universal Serial Bus (USB) port, or a docking port, or some other wired port connection, can be included. The port device 590 can, for example, be utilized to establish a wired connection to other computing devices, such as other communication devices 500, network access devices, a personal computer, a printer, a display screen, or other processing devices capable of receiving and/or transmitting data. In some implementations, the port device 590 allows the mobile device 500 to synchronize with a host device using one or more protocols, such as, for example, the TCP/IP, HTTP, UDP and any other known protocol.

The mobile device 500 can also include a camera lens and sensor 580. In some implementations, the camera lens and sensor 580 can be located on the back surface of the mobile device 500. The camera can capture still images and/or video.

The mobile device 500 can also include one or more wireless communication subsystems, such as an 802.11b/g communication device 586, and/or a Bluetooth™ communication device 588. Other communication protocols can also be supported, including other 802.x communication protocols (e.g., WiMax, Wi-Fi, 3G), code division multiple access (CDMA), global system for mobile communications (GSM), Enhanced Data GSM Environment (EDGE), etc.

FIG. 5B illustrates another example of configurable top-level graphical user interface of device 500. The device 500 can be configured to display a different set of display objects.

In some implementations, each of one or more system objects of device 500 has a set of system object attributes associated with it; and one of the attributes determines whether a display object for the system object will be rendered in the top-level graphical user interface. This attribute can be set by the system automatically, or by a user through certain programs or system functionalities as described below. FIG. 5B shows an example of how the Notes object 552 (not shown in FIG. 5A) is added to and the Web Video object 516 is removed from the top graphical user interface of device 500 (e.g. such as when the attributes of the Notes system object and the Web Video system object are modified).

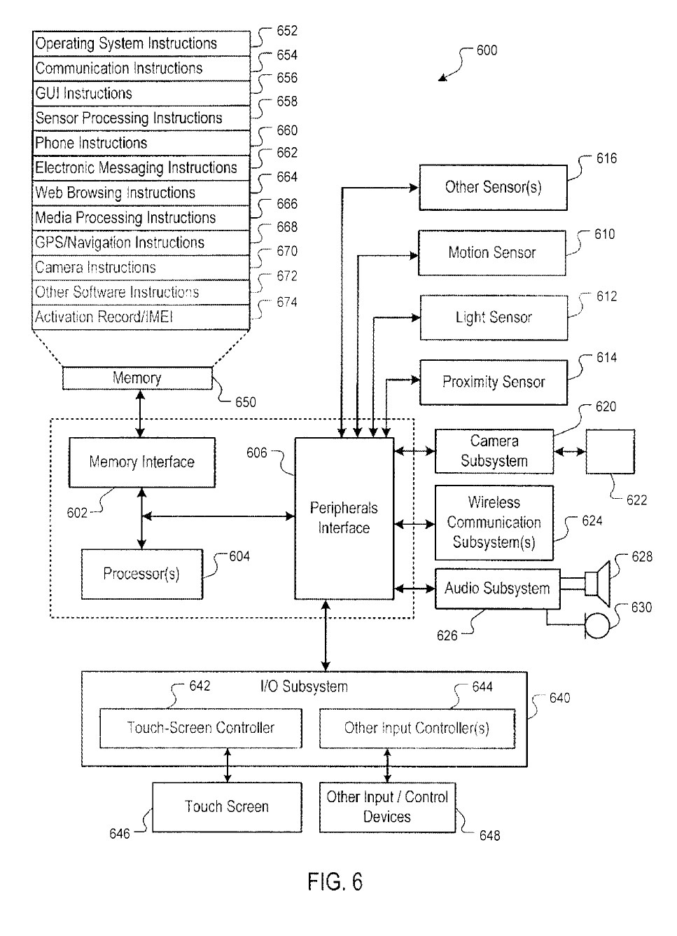

FIG. 6 is a block diagram 600 of an example implementation of a mobile device (e.g., mobile device 500). The mobile device can include a memory interface 602, one or more data processors, image processors and/or central processing units 604, and a peripherals interface 606. The memory interface 602, the one or more processors 604 and/or the peripherals interface 606 can be separate components or can be integrated in one or more integrated circuits. The various components in the mobile device can be coupled by one or more communication buses or signal lines.

Sensors, devices, and subsystems can be coupled to the peripherals interface 606 to facilitate multiple functionalities. For example, a motion sensor 610, a light sensor 612, and a proximity sensor 614 can be coupled to the peripherals interface 606 to facilitate the orientation, lighting, and proximity functions described with respect to FIG. 5A. Other sensors 616 can also be connected to the peripherals interface 606, such as a positioning system (e.g., GPS receiver), a temperature sensor, a biometric sensor, or other sensing device, to facilitate related functionalities.

A camera subsystem 620 and an optical sensor 622, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 624, which can include radio frequency receivers and transmitters and/or optical (e.g., infrared) receivers and transmitters. The specific design and implementation of the communication subsystem 624 can depend on the communication network(s) over which the mobile device is intended to operate. For example, a mobile device can include communication subsystems 624 designed to operate over a GSM network, a GPRS network, an EDGE network, a Wi-Fi or WiMax network, and a Bluetooth™ network. In particular, the wireless communication subsystems 624 may include hosting protocols such that the mobile device may be configured as a base station for other wireless devices.

An audio subsystem 626 can be coupled to a speaker 628 and a microphone 630 to facilitate voice-enabled functions, such as voice recognition, voice replication, digital recording, and telephony functions.

The I/O subsystem 640 can include a touch screen controller 642 and/or other input controller(s) 644. The touch-screen controller 642 can be coupled to a touch screen 646. The touch screen 646 and touch screen controller 642 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 646.

The other input controller(s) 644 can be coupled to other input/control devices 648, such as one or more buttons, rocker switches, thumb-wheel, infrared port, USB port, and/or a pointer device such as a stylus. The one or more buttons (not shown) can include an up/down button for volume control of the speaker 628 and/or the microphone 630.

In one implementation, a pressing of the button for a first duration may disengage a lock of the touch screen 646; and a pressing of the button for a second duration that is longer than the first duration may turn power to the mobile device on or off. The user may be able to customize a functionality of one or more of the buttons. The touch screen 646 can, for example, also be used to implement virtual or soft buttons and/or a keyboard.

In some implementations, the mobile device can present recorded audio and/or video files, such as MP3, AAC, and MPEG files. In some implementations, the mobile device can include the functionality of an MP3 player, such as an iPod™. The mobile device may, therefore, include a 32-pin connector that is compatible with the iPod™. Other input/output and control devices can also be used.

The memory interface 602 can be coupled to memory 650. The memory 650 can include high-speed random access memory and/or non-volatile memory, such as one or more magnetic disk storage devices, one or more optical storage devices, and/or flash memory (e.g., NAND, NOR). The memory 650 can store an operating system 652, such as Darwin, RTXC, LINUX, UNIX, OS X, WINDOWS, or an embedded operating system such as VxWorks. The operating system 652 may include instructions for handling basic system services and for performing hardware dependent tasks. In some implementations, the operating system 652 can be a kernel (e.g., UNIX kernel).

The memory 650 may also store communication instructions 654 to facilitate communicating with one or more additional devices, one or more computers and/or one or more servers. The memory 650 may include graphical user interface instructions 656 to facilitate graphic user interface processing; sensor processing instructions 658 to facilitate sensor-related processing and functions; phone instructions 660 to facilitate phone-related processes and functions; electronic messaging instructions 662 to facilitate electronic-messaging related processes and functions; web browsing instructions 664 to facilitate web browsing-related processes and functions; media processing instructions 666 to facilitate media processing-related processes and functions; GPS/Navigation instructions 668 to facilitate GPS and navigation-related processes and instructions; camera instructions 670 to facilitate camera-related processes and functions; and/or other software instructions 672 to facilitate other processes and functions. The memory 650 may also store other software instructions (not shown), such as web video instructions to facilitate web video-related processes and functions; and/or web shopping instructions to facilitate web shopping-related processes and functions. In some implementations, the media processing instructions 666 are divided into audio processing instructions and video processing instructions to facilitate audio processing-related processes and functions and video processing-related processes and functions, respectively. An activation record and International Mobile Equipment Identity (IMEI) 674 or similar hardware identifier can also be stored in memory 650.

All of the methods and processes described above can be embodied in, and fully automated via, software code modules executed by one or more general purpose computers. The code modules can be stored in any type of computer-readable medium or other computer storage device. Some or all of the methods can alternately be embodied in specialized computer hardware.

Although this invention has been described in terms of certain embodiments and applications, other embodiments and applications that are apparent to those of ordinary skill in the art, including embodiments which do not provide all of the features and advantages set forth herein, are also within the scope of the invention. Accordingly, the scope of the present invention is intended to be defined only by reference to the following claims.

What is claimed is:

1. A method for providing multimedia content on an electronic device, the method comprising:
generating a graphical user interface with an application to be displayed on the electronic device;
displaying the graphical user interface comprising at least calling, with the application, one or more native application programming interfaces to provide multimedia services through the graphical user interface, the application to control the multimedia content via calls to the one or more native application programming interfaces.

2. The method of claim 1, wherein the multimedia services comprise at least starting and stopping playback of the multimedia content.

3. The method of claim 1, wherein the multimedia services comprise at least scaling a size of the multimedia content display.

4. The method of claim 1, wherein the application provides the one or more native application programming interface with an identifier corresponding to the multimedia content.

5. The method of claim 4, wherein the identifier comprises a Universal Resource Locator (URL).

6. The method of claim 1, wherein calls from the application to the one or more native application programming interfaces provide transitions for the multimedia playback.

7. An apparatus to provide multimedia content on an electronic device, the method comprising:
means for generating a graphical user interface with an application to be displayed on the electronic device;
means for displaying the graphical user interface comprising at least calling, with the application, one or more native application programming interfaces to provide multimedia services through the graphical user interface, the application to control the multimedia content via calls to the one or more native application programming interfaces.

8. The apparatus of claim 7 further comprising:
means for determining a rotation of the electronic device;
means for automatically notifying the application of the rotation of the electronic device; and
means for rotating the display of the multimedia content in response to the rotation of the electronic device.

9. An article comprising a computer-readable medium having stored thereon instructions that, when executed, cause one or more processor to provide multimedia content on an electronic device by:
generating a graphical user interface with an application to be displayed on the electronic device;
displaying the graphical user interface comprising at least calling, with the application, one or more native application programming interfaces to provide multimedia services through the graphical user interface, the application to control the multimedia content via calls to the one or more native application programming interfaces.

10. The article of claim 9, wherein the multimedia services comprise at least starting and stopping playback of the multimedia content.

11. The article of claim 9, wherein the multimedia services comprise at least scaling a size of the multimedia content display.

12. The article of claim 9, wherein the application provides the one or more native application programming interface with an identifier corresponding to the multimedia content.

13. The article of claim 12, wherein the identifier comprises a Universal Resource Locator (URL).

14. The article of claim 9, wherein calls from the application to the one or more native application programming interfaces provide transitions for the multimedia playback.

15. A mobile wireless electronic system comprising:
a processor;
a wireless transceiver coupled with the processor;
a memory coupled with the processor;
a third-party application to provide a graphical user interface on the mobile wireless electronic system;
one or more runtime application programming interface modules communicatively coupled with the third-party application, the one or more runtime application programming interface modules to provide multimedia services to the graphical user interface for the third-party application, wherein the third-party application can control the multimedia content via calls to the one or more runtime application programming interfaces; and
one or more native software modules to provide multimedia services to the third-party application via the one or more runtime application programming interfaces, wherein the one or more native software modules are configured to provide multimedia services to multiple third-party applications and are native to the mobile wireless electronic device.

16. The mobile wireless electronic device of claim 15, wherein the one or more native software modules provide at least transitions for the multimedia playback by the third-party application.

17. The mobile wireless electronic device of claim 15, wherein the one or more native software modules provide at least scaling a size of the multimedia content display.

18. The mobile wireless electronic device of claim 15, wherein the one or more native software modules provide at least starting and stopping playback of the multimedia content.

19. The mobile wireless electronic device of claim 15, wherein the one or more native software modules receive an identifier corresponding to the multimedia content from the third-party application, retrieves the multimedia content and provides the multimedia content to the third-party application via one or more of the application programming interface modules.
